(19) United States
(12) Patent Application Publication
(10) Pub. No.: US 2011/0086177 A1
(43) Pub. Date: Apr. 14, 2011

(54) THERMAL SPRAY METHOD FOR PRODUCING VERTICALLY SEGMENTED THERMAL BARRIER COATINGS

(75) Inventor: Xinqing Ma, Willington, CT (US)

(73) Assignee: WALBAR INC. Peabody Industrial Center, Peabody, MA (US)

(21) Appl. No.: 12/895,302

(22) Filed: Sep. 30, 2010

Related U.S. Application Data
(60) Provisional application No. 61/251,322, filed on Oct. 14, 2009.

(51) Int. Cl. C23C 4/00; B05D 3/00

(52) U.S. Cl. 427/446; 427/398.1

(57) ABSTRACT

The invention provides a method for forming a thermal barrier coating having vertical cracks for improved thermal and mechanical stress tolerance. The method can include depositing a first sub-layer on a substrate at a first temperature T1, followed by depositing a second sub-layer on the first sub-layer at a second temperature T2, wherein T2 is less than T1 such that a temperature gradient having a negative heat flux toward the top of the second sub-layer is created, thereby introducing thermal stress in the sub-layers causing vertical cracks to be formed in the sub-layers. The method then involves repeating steps (a) and (b) for n cycles to form the thermal barrier coating comprising the vertical cracks, wherein n is an integer from 1 to 200.

### RELATED APPLICATIONS/INCORPORATION BY REFERENCE

This application claims priority to U.S. Provisional Application Ser. No. 61/251,322, filed Oct. 14, 2009, the entire contents of which are incorporated herein by reference.

All documents cited or referenced herein and all documents cited or referenced in the herein cited documents, together with any manufacturer's instructions, descriptions, product specifications, and product sheets for any products mentioned herein or in any document incorporated by reference herein, are hereby incorporated by reference, and may be employed in the practice of the invention.

### BACKGROUND OF THE INVENTION

1. Field of the Invention

This invention relates generally to protective thermal coating systems for substrates exposed to high temperature environments. The coating systems include vertically-oriented cracks to improve the thermal stress tolerance and spallation resistance of the coating systems. More specifically, the present invention relates to spraying processes for forming protective thermal barrier coatings that include vertically-oriented cracks for improved resistance to thermal strain.

2. Background

Thermal barrier coating (TBC) systems are often used to protect and insulate the internal components of gas turbine engines (e.g., buckets, nozzles, airfoils and shrouds), which are regularly exposed to high-temperature environments during engine operation. These components when exposed to high temperatures (e.g., upwards of 1,000° C.) can oxidize, corrode and become brittle. Gas turbine engine components protected by TBCs have less deterioration from high-temperature stress, thereby allowing the engine as a whole to perform more efficiently and for an extended lifetime at high temperatures. These TBC systems should have low thermal conductivity, should strongly adhere to the underlying component, and should remain adhered throughout the operating life of the engine. Coating systems capable of satisfying these requirements may include a metallic bond coating that adheres a thermal-insulating ceramic layer to the component. Metal oxides, such as zirconia (ZrO₂) partially or fully stabilized by yttria (Y₂O₃), magnesia (MgO) or other oxides, have been widely employed as the materials for the thermal-insulating ceramic layer.

An important aspect of TBC systems is the underlying microstructure of the system. Microstructure refers to the structure of the material or coating on a microscopic level. Components of microstructure include the phases present, grain size, precipitate and/or dispersoid size, density/porosity, cracking, and the presence and size of lamellar splats (in thermal spray methods). Weaknesses in the microstructure induced by thermal and/or mechanical strains can result in the failure of the TBC due to coating buckling, peeling, detaching and even spallation during service. Particularly vulnerable areas include the interface of the metallic substrate and the overlying ceramic coats.

One approach for improving TBC stability, longevity and resistance to spallation is to introduce columnar grains or intentionally-formed vertical cracks in certain TBCs. The cracks alleviate thermal stress in the ceramic layer. Often such TBC systems are identified as “dense and vertically-cracked thermal barrier coatings” (DVC-TBC). However, prior methods for producing vertically cracked TBCs have certain limitations, including inability to easily control crack density or the depth of the cracks within the layer. The ability to control crack density and depth would be advantageous because performance characteristics are directly affected by the degree and location of cracking in the TBC system. Improved methods for providing vertically-cracked TBCs such that crack density and depth are more easily controlled would be an advance in the art. The present invention provides such a solution.

### SUMMARY OF THE INVENTION

The purpose and advantages of the present invention will be set forth in and apparent from the description that follows. Additional advantages of the invention will be realized and attained by the methods and systems particularly pointed out in the written description and claims hereof, as well as from the appended drawings.

The present invention relates to a new and useful process for preparing and fabricating vertically-cracked thermal barrier coatings (TBCs) that have enhanced durability and longevity during operation due to the effects of cracking on relieving thermal and mechanical stress encountered during operation, wherein the density and depth of the cracking is controllable by the process itself.

The invention can be used with gas turbine engines; however, the concepts of the invention are intended to have a wider applicability both within the gas turbine engine industry and within other industries as well.

In one embodiment, the present invention relates to a method for forming a thermal barrier coating comprising vertical cracks, the method comprising the steps of: depositing a first sub-layer on a substrate at a first temperature T1, followed by depositing a second sub-layer on the first sub-layer at a second temperature T2, wherein the T2 is less than the T1 such that a temperature gradient having a negative heat flux toward the top of the second sub-layer is created thereby introducing thermal stress in the sub-layers causing vertical cracks to be formed in the sub-layers. The method then involves repeating steps (a) and (b) for n cycles to form the thermal barrier coating comprising the vertical cracks, wherein n is an integer from 1 to 200. The first and second temperatures are achieved via a first and second set of parameters applied during the coating process.

In another embodiment, the present invention provides a method of forming a vertically-cracked thermal barrier coating, said coating comprising n sub-layers, the method comprising the steps of: depositing a sub-layer i using a first set of parameters to achieve a first temperature T1; depositing a sub-layer i+1 over sub-layer i using a second set of parameters to achieve a second temperature T2, wherein T2 is less than T1 such that heat diffuses towards the surface of sub-layer i+1 causing vertical cracking; and repeating steps (a) and (b) to form the coating having n sub-layers.

In certain embodiments, the sub-layers are deposited by a thermal spraying method. The thermal spraying method can be by plasma spraying or high-velocity oxy-fuel (HVOF) spraying.

In certain other embodiment, the parameters used to achieve the temperatures of the sub-layers can be the same or different. Parameters contemplated by the present invention include any suitable adjustable parameters known in the art that are typical of thermal spraying methods, which include, but are not limited to, input power of the thermal sprayer, standoff distance (i.e., distance from the tip of the spraying device and the surface onto which the materials is sprayed) and working gas flow (e.g., a source of cooling air or gas, such as, liquid nitrogen).

In yet other embodiments, the sub-layer material is a ceramic material. The sub-layer material may also be an abradable ceramic.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

So that those having ordinary skill in the art to which the subject invention pertains will more readily understand how to make and use the invention as described herein, preferred embodiments thereof will be described in detail below, with reference to the drawings, wherein:

FIG. 1a shows a schematic of a coating structure prepared by an embodiment of the inventive method, which provides a topcoat comprising multiple sub-layers formed during each coating pass or cycle, where “n” represents the total number of coating passes of the spraying process. Among the sub-layers, sub-layers i and i+1 are applied using different process parameters.

FIG. 1b illustrates the temperature distribution and heat flux direction using the process of the invention wherein the direction of heat flux is upwards toward the surface of sub-layer i+1. In this system, the surface temperature T1 on sub-layer i is higher than temperature T2 on sub-layer i+1, which causes the heat flux to be directed toward the surface of sub-layer i+1 oriented generally in a direction that is perpendicular to the layers.

FIG. 2a shows a schematic of a coating structure prepared by another embodiment of the inventive method, which includes a topcoat comprising multiple sub-layers formed during each coating pass or cycle, where “n” represents the total number of coating passes of the spraying process.

FIG. 2b shows a cyclic temperature profile recorded during deposition of the sub-layers, where cooling is turned on and off at a time interval corresponding to the time for applying sub-layers.

FIG. 3 shows a schematic of vertical crack formation in this invention. Microcracks in sub-layer i are formed by cyclic thermal stress (e.g., as induced by the approaches of FIG. 1 or FIG. 2) while applying the sub-layer. Some of the microcracks extend into next sub-layer i+1 to form vertical macrocracks continuously during the coating process. FIG. 4 depicts the microstructure of a vertically-cracked TBC of the invention made by plasma spray of Metco 204NS in accordance with Example 1.

FIG. 5 depicts the microstructure of a vertically cracked TBC made by plasma spray of Praxair ZrO-271-03 in accordance with Example 2.

FIG. 6a shows a surface temperature record during coating cycles at two different standoff distances.

FIG. 6b shows the microstructure of vertically-cracked TBCs prepared in accordance with Example 3.

FIG. 7 depicts the microstructure of vertically-cracked TBC made by thermal cycling using compressed air jet cycling of 2 minutes on-time at 50 Psi and 2 minutes off-time, as described in Example 4.

FIG. 8 depicts the microstructure of a vertically-cracked TBC with an abradable top coating, as described in Example 5.

### DESCRIPTION OF THE INVENTION

A thermal spray method for producing vertically-segmented thermal barrier coatings is disclosed. The method includes making a vertically-segmented/cracked thermal barrier coating by a thermal spray process. It is generally known that (i) a ceramic layer will easily suffer cracking if residual stress is sufficiently higher than its fracture strength; (ii) a thermal cyclic condition will be more likely to crack a ceramic coating compared to a constant thermal condition; (iii) the orientation of cracking and crack extension/growth in a coating can be partially controlled by the direction of a heat flux in the coating; (iv) microcracks within a thin laminate or sub-layer can be formed readily at a relatively low heat flux input (positive flux) or output (negative flux); and (v) a macrocrack can be formed by the growth and connection of microcracks.

The method disclosed introduces a cyclic heat input into a single sub-layer while applying a ceramic topcoat in a TBC by thermal spray. The cyclic heat input is alternately applied to the sub-layers during continuous coating deposition and thus results in a sufficient thermal stress within the sub-layers to cause microcracking.

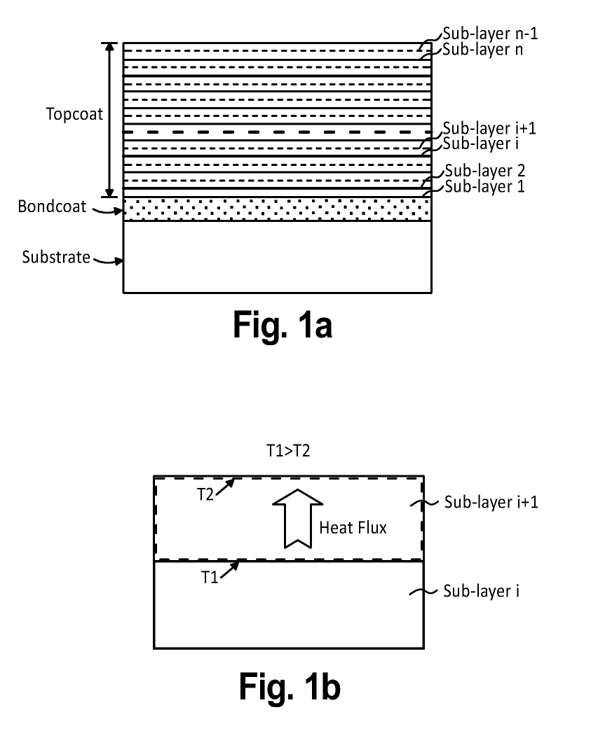

The cyclic heat input condition can be achieved by any suitable approach. In one embodiment, the cyclic heat input is achieved by the method depicted in FIG. 1 and described as follows.

In this first embodiment, a topcoat is deposited via a spraying process in multiple coating passes/cycles up to total cycle number n. A sub-layer i+1 is formed on the previous sub-layer i in the next coating cycle. Therefore, the process parameters for depositing each sub-layer can be changed individually to control the desired microstructure or thermal condition. In FIG. 1b, for example, sub-layers i and i+1 are deposited using different process parameters to achieve a lower surface temperature T2 on sub-layer i+1 than temperature T1 on previously applied sub-layer i. The negative heat flux toward the top surface results in a temperature gradient, and the associated thermal stress can induce vertical cracks in the sub-layers. The process parameters may include, but are not limited to, input power, standoff distance, and working gas flow (e.g., a cooling gas stream, such as, liquid nitrogen). In this case, it is possible to change coating microstructural features such as overall porosity and crack density.

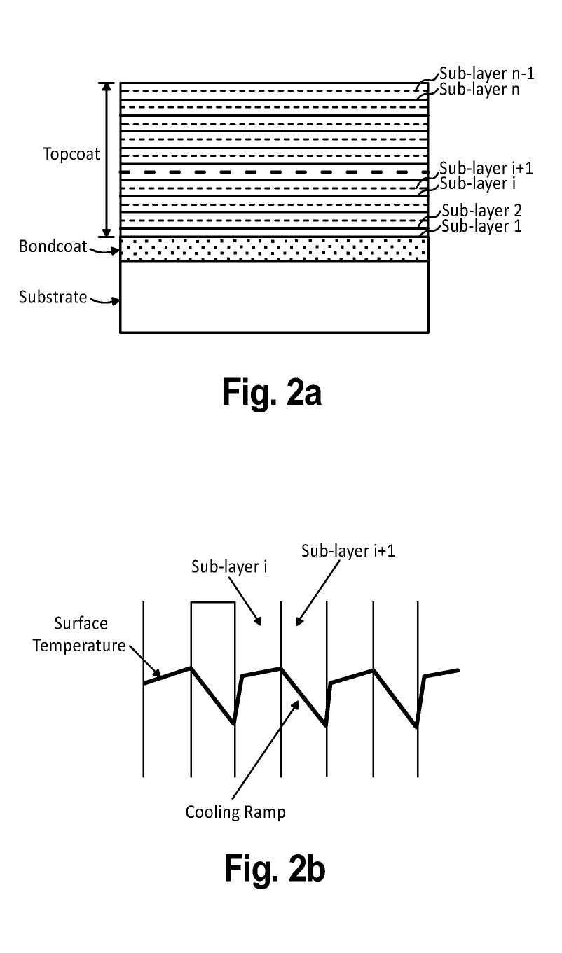

In another embodiment, the cyclic heat input is achieved by the method depicted in FIG. 2 and described as follows. A topcoat is deposited via a spraying process in multiple coating passes/cycles up to total cycle number n. Thermal management can be applied to selected sub-layers by a direct cooling technique while it is deposited. In FIG. 2b, for example, cyclic cooling is used to reduce the surface temperature during application of sub-layer i+1. In the cycles, alternate cooling on and off provides a cyclic temperature profile in the history of the coating process. The thermal gradient in the cooling ramp will be mainly responsible for inducing thermal stress and resultant vertical cracks in the sub-layers. Cooling media can include, but is not limited to, air, N₂, Ar, liquid N₂ and CO₂ and so on. In this case, process parameters are consistent, but the change in temperature can affect coating microstructure, porosity and crack density.

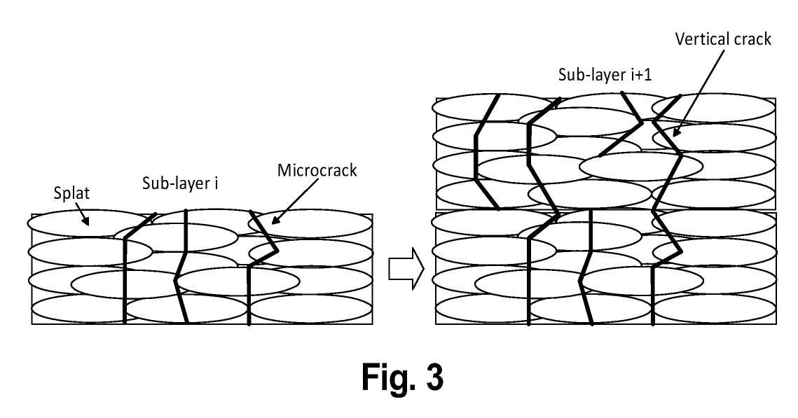

In certain embodiments, the mechanism for forming vertical cracks is as follows: first, vertical microcracks are initialized and developed in individual sub-layers, mostly due to the thermal stress induced under the thermal cycling condition during the coating process. Second, the microcracks will propagate across sub-layers and connect to form macrocracks extending partially or entirely through the coating thickness. In addition, the volume shrinkage of solidified splats also contributes to crack formation in the coating. The orientation of cracking is dominated by the direction of heat flux normal (i.e., generally perpendicular) to the surface, therefore, vertical cracks are formed accordingly as demonstrated in FIG. 3.

The methods of the present invention can utilize any suitable thermal spraying technique known in the art, including, for example, plasma spraying or high-velocity oxygen-fuel (HVOF) spraying, which is a well-known process that efficiently uses high kinetic energy and controlled thermal output to produce dense, low-porosity coatings that exhibit high bond strengths, low oxides and extremely fine as-sprayed finishes. The coatings can be sprayed to a thickness not normally associated with dense, thermal-sprayed coatings. This process uses an oxygen-fuel mixture. Depending on user requirements, propylene, propane, hydrogen or natural gas may be used as the fuel in gas-fueled spray systems and kerosene as the fuel in liquid-fueled systems. The coating material, in powdered form, is fed axially through the gun, generally using nitrogen as a carrier gas. The fuel is thoroughly mixed with oxygen within the gun and the mixture is then ejected from a nozzle and ignited outside the gun. The ignited gases surround and uniformly heat the powdered spray material as it exits the gun and is propelled to the workpiece surface. As a result of the high kinetic energy transferred to the particles through the HVOF process, the coating material generally does not need to be fully melted. Instead, the powder particles are in a molten state and flatten plastically as they impact the workpiece surface. The resulting coatings have very predictable chemistries that are homogeneous and have a fine granular structure. These coatings can survive harsh service conditions, particularly in wear and many corrosion applications, which greatly increase component service life. The smooth, as-sprayed surface, uniform chemistry, and low porosity of the coating can be finished to very smooth surface profiles. Further description and use of HVOF can be found, for example, in U.S. Pat. Nos. 7,150,921; 7,132,166; 6,924,007; 6,886,757; 6,793,976; 6,581,446; 6,503,576; and 6,346,134, each of which is incorporated by reference herein in their entireties.

In addition, general methods, parameters and techniques are well-known for applying thermal barrier coatings. The skilled artisan may consult any number of readily available references or texts to carry out the spraying processes involved in the present invention. Further reference can be made to U.S. Pat. Nos. 7,622,195; 7,579,087; 7,501,187; 7,476,450; 7,455,913; 7,416,788; 7,413,798; 7,376,518; 7,298,818; 7,166,372; 7,150,926; 6,979,991; 6,974,637; 6,833,203; 6,635,124; 6,607,611; 6,585,878; 6,485,845; 6,485,844; 6,472,018; 6,447,854; 6,444,259; 6,382,920; 6,342,278; 6,284,323; 6,255,001; 6,231,991; 6,177,200; 6,117,560; 6,106,959; 6,001,492; 5,972,424; 5,912,087; 5,763,107; 5,667,663; 5,645,893; 5,538,796; 5,015,502; and 4,880,614, each of which discloses basic methods for applying thermal barrier coatings and is incorporated herein by reference.

The disclosed method has some unique aspects and advantages over existing dense-vertically cracked thermal barrier coating (DVC-TBC) thermal spray techniques in terms of process control, coating microstructure, and properties, including, but not limited to, the following: (1) a well-controlled process—the method enables a user to set up a process by changing coating parameters or retrofitting coating equipment with a cooling unit, etc.; surface temperature monitoring in-situ enables the recording and control of thermal conditions during the coating process; (2) desired microstructure—the method achieves vertical cracks with controlled crack density (crack number per inch), achieves a higher coating porosity relative to conventional DVC-TBC, and achieves cracking even for thinner coatings (versus prior art coatings where cracking occurs only as the coating attains thickness); (3) superior coating properties—the resultant TBC will have the desired vertical cracks and adjustable higher porosity (lower thermal conductivity), which will be beneficial to improve spallation resistance and thermal insulation property.

### EXAMPLES

The structures, materials, compositions, and methods described herein are intended to be representative examples of the invention, and it will be understood that the scope of the invention is not limited by the scope of the examples. Those skilled in the art will recognize that the invention may be practiced with variations on the disclosed structures, materials, compositions and methods, and such variations are regarded as within the ambit of the invention.

The following examples illustrate various exemplary embodiments of the methods described in this disclosure:

### Example 1

### Cracked TBC Using Commercial Powder Metco 204NS

Process: Plasma spray for bondcoat and topcoat

Equipment: Sulzer Metco 9MB plasma gun system

Parameters: Spray distance: 2.5″, Plasma power: 600 A/80V, working gas N2: 80 flowrate@70 Psi.

Results: Microstructure with vertical cracks (see FIG. 4)

### Example 2

### Cracked TBC Using Commercial Powder Praxair ZrO-271-03

Process: Plasma spray for bondcoat and topcoat

Equipment: Sulzer Metco 9MB plasma gun system

Parameters: Spray distance: 2.5″, Plasma power: 600 A/80V, working gas N2: 80 flowrate@70 Psi.

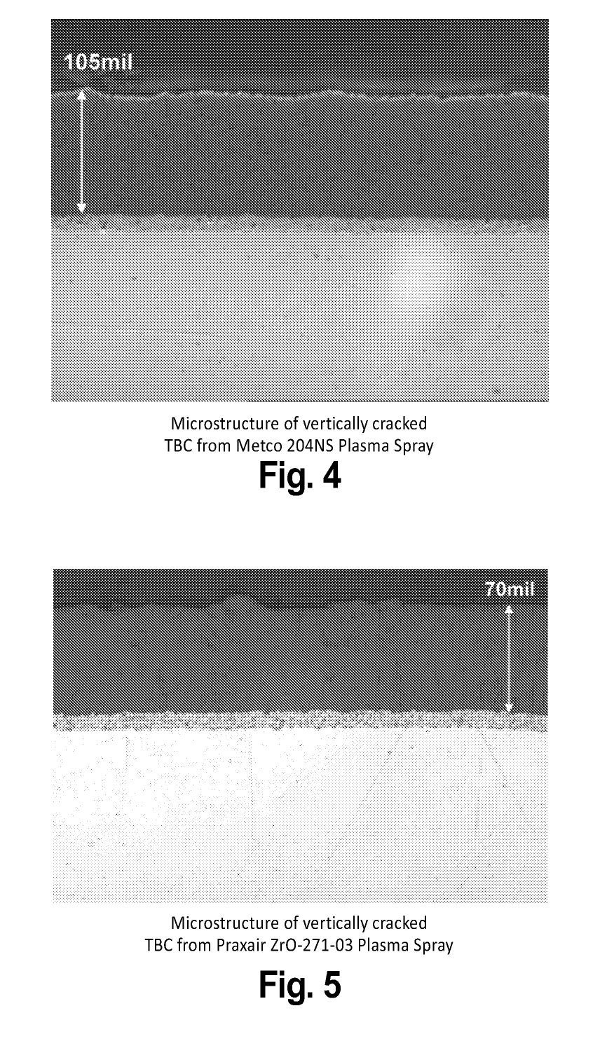

Results: Microstructure with vertically cracks (see FIG. 5)

### Example 3

### Cracked TBC Using Commercial Powder Metco 204NS. (Metlab ID#5056)

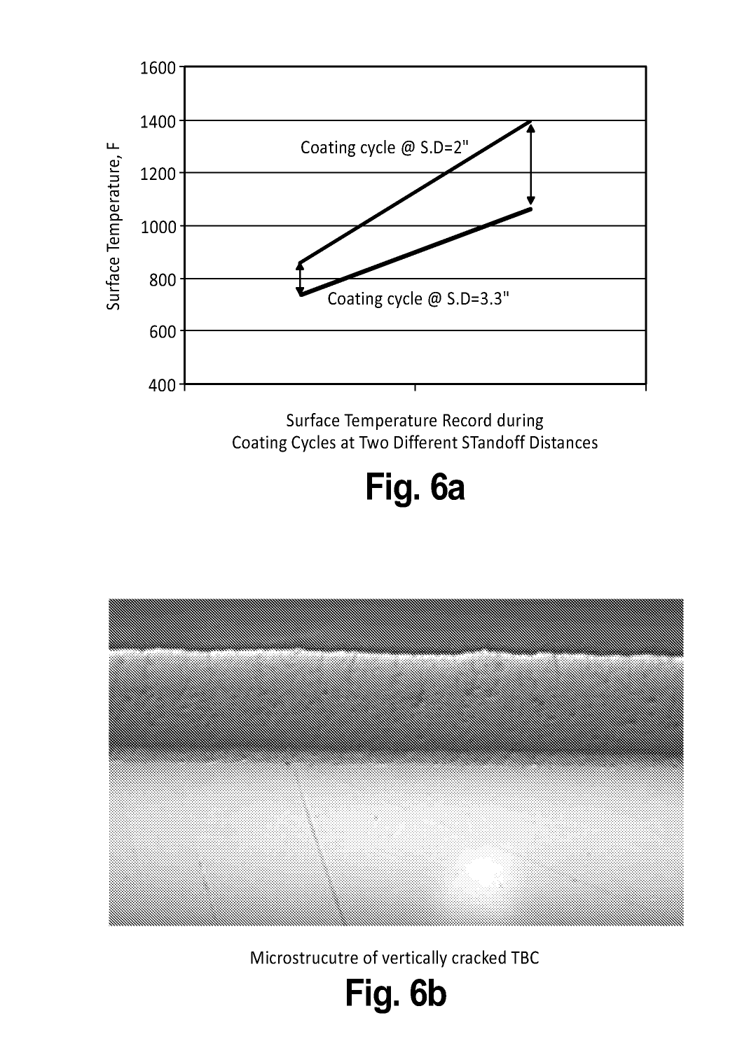

Process: Plasma spray for bondcoat and topcoat using thermal control method (Temperature record see FIG. 6a)

Equipment: Sulzer Metco 9MB plasma gun system

Parameters: Spray distance: 2.5″ and 3.5″ for each sub-layer alternately by robot movement, Plasma power: 600 A/80V, working gas N2: 80 flowrate@70 Psi.

Results: Microstructure with vertical cracks (see FIG. 6b)

### Example 4

### Cracked TBC Using Commercial Powder Metco 204NS

Process: Plasma spray for bondcoat and topcoat using external cooling

Equipment: Sulzer Metco 9MB plasma gun system

Parameters: Spray distance: 2.0″, Plasma power: 600 A/78V, working gas N2: 80 flowrate@70 Psi.

Cooling on: 2 minutes/50 PSI; cooling off: 2 minutes.

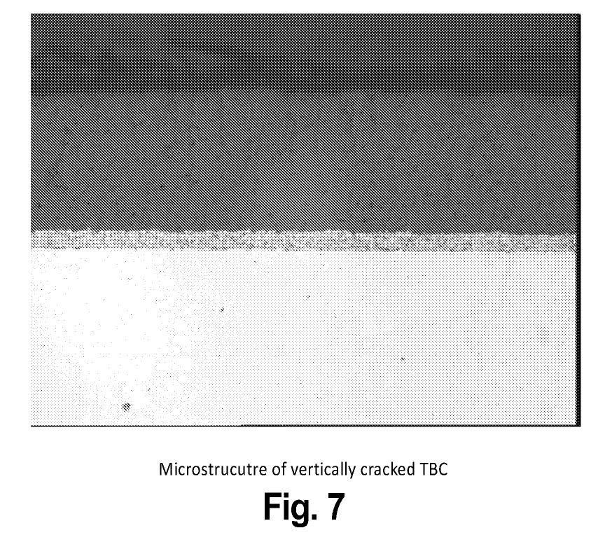

Results: Microstructure with vertically cracks: FIG. 7: Microstructure of vertically-cracked TBC made by thermal cycling using compressed air jet cycling of 2 minutes on-time at 50 Psi and 2 min off-time.

### Example 5

### Cracked TBC and Abradable Coating Using Commercial Powders

Materials: TBC topcoat: Metco 204NS; abradable coat: Metco Durabrade 2460NS

Process: Plasma spray for bondcoat and topcoat

Equipment: Sulzer Metco 9MB plasma gun system

TBC Parameters: Spray distance: 2.5″, Plasma power: 600 A/80V, working gas N2: 80 flowrate@70 Psi.

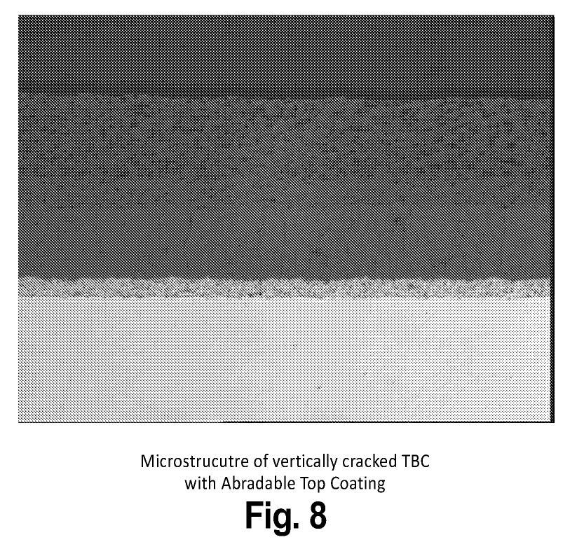

Results: Microstructure with vertical cracks (see FIG. 8)

Although the methods and compositions of the subject invention have been described with respect to preferred embodiments, those skilled in the art will readily appreciate that changes and modifications may be made thereto without departing from the spirit and scope of the subject invention as defined by the appended claims.

What is claimed is:

1. A method for forming a thermal barrier coating comprising vertical cracks, the method comprising the steps of:
(a) depositing a first sub-layer on a substrate at a first temperature T1;
(b) depositing a second sub-layer on the first sub-layer at a second temperature T2, wherein the T2 is less than the T1 such that a temperature gradient having a negative heat flux toward the top of the second sub-layer is created thereby introducing thermal stress in the sub-layers causing vertical cracks to be formed in the sub-layers;
(c) repeating steps (a) and (b) for n cycles to form the thermal barrier coating comprising the vertical cracks, wherein n is an integer from 1 to 200, inclusive.

2. The method of claim 1, wherein the sub-layers are deposited by a thermal spraying method.

3. The method of claim 2, wherein the thermal spraying method is by plasma spraying or high-velocity oxygen-fuel (HVOF) spraying.

4. The method of claim 1, wherein the first temperature T1 is achieved by a first set of parameters.

5. The method of claim 4, wherein the parameters are selected from the group consisting of plasma spraying input power, standoff distance, and working gas flow.

6. The method of claim 1, wherein the second temperature T2 is achieved by a second set of parameters.

7. The method of claim 6, wherein the parameters are selected from the group consisting of plasma spraying input power, standoff distance, and working gas flow.

8. The method of claim 1, wherein the sub-layer material is ceramic.

9. The method of claim 1, wherein the sub-layer material is an abradable ceramic.

10. A method of forming a vertically cracked thermal barrier coating, said coating comprising n sub-layers, the method comprising the steps of:
(a) depositing a sub-layer i using a first set of parameters to achieve a first temperature T1;
(b) depositing a sub-layer i+1 over sub-layer i using a second set of parameters to achieve a second temperature T2, wherein T2 is less than T1 such that heat diffuses towards the surface of sub-layer i+1 causing vertical cracking;
(c) repeating steps (a) and (b) to form the coating having n sub-layers.

11. The method of claim 10, wherein the sub-layers are deposited by a thermal spraying method.

12. The method of claim 11, wherein the thermal spraying method is by plasma spraying or high-velocity oxygen-fuel (HVOF) spraying.

13. The method of claim 10, wherein the first set of parameters and the second set of parameters are the same.

14. The method of claim 10, wherein the first set of parameters and the second set of parameters are the different.

15. The method of claim 10, wherein the first or second set of parameters are selected from the group consisting of plasma spraying input power, standoff distance, and working gas flow.

16. The method of claim 10, wherein the sub-layer material is ceramic.

17. The method of claim 10, wherein the sub-layer material is an abradable ceramic.

18. The method of claim 10, wherein n is an integer between 2 and 200, inclusive.
